(19) United States
(12) Patent Application Publication
(10) Pub. No.: US 2015/0156149 A1
(43) Pub. Date: Jun. 4, 2015

(54) METHOD AND APPARATUS FOR SHARING CONTENT FROM THIRD PARTY WEBSITES VIA MESSAGING

(71) Applicant: AT&T Mobility II LLC, Atlanta, GA (US)

(72) Inventors: Chad C. Keith, Seattle, WA (US); John Powell, Seattle, WA (US)

(73) Assignee: AT&T Mobility II LLC, Atlanta, GA (US)

(21) Appl. No.: 14/096,721

(22) Filed: Dec. 4, 2013

(51) Int. Cl. H04L 12/58

(52) U.S. Cl. CPC H04L 51/10

(57) ABSTRACT

A method, computer-readable storage device and apparatus for sending a content of a third party website via a messaging service are disclosed. For example, the method provides a source code to the third party website to enable the sending of the content via the messaging service, receives a request to send the content to a mobile endpoint device of a recipient via the messaging service, wherein the request originates from the third party website, receives a telephone number of a mobile endpoint device and sends the content to the mobile endpoint device associated with the telephone number of the recipient as a message via the messaging service, wherein the message is identified as being sent from a mobile endpoint device of a sender.

### BACKGROUND

Third party websites generally provide a rich amount of content. In addition, with the advent of social networking users tend to send or share content that the users find on the third party websites. Sharing content on the third party websites also helps the third party website providers as more traffic is brought to the third party's websites and helps increase the popularity of the websites, thereby leading to possibly higher revenues.

Currently, a user may share content on the third party website by uploading the content to a social networking website such as Facebook® or Twitter®. Another option may be to insert the content into an email or attach the content to the email manually by the user. These approaches require the users to be more proactive in the sharing of contents, thereby causing some content on some third party's website not to be shared due to the fact that the users do not want to expend the time required to bring about the sharing of such content.

### SUMMARY

In one embodiment, the present disclosure provides a method, computer-readable storage device, and apparatus for sending a content of a third party website via a messaging service. In one embodiment, the method provides a source code to the third party website to enable the sending of the content via the messaging service, receives a request to send the content to a mobile endpoint device of a recipient via the messaging service, wherein the request originates from the third party website, receives a telephone number of a mobile endpoint device and sends the content to the mobile endpoint device associated with the telephone number of the recipient as a message via the messaging service, wherein the message is identified as being sent from a mobile endpoint device of a sender.

### BRIEF DESCRIPTION OF THE DRAWINGS

The essence of the present disclosure can be readily understood by considering the following detailed description in conjunction with the accompanying drawings, in which:

FIG. 1 illustrates one example of a communications network of the present disclosure;

FIG. 2 illustrates example screenshots;

FIG. 3 illustrates an example flowchart of a method for sending content of a third party website via a messaging service;

FIG. 4 illustrates another example flowchart of a method for sending content of a third party website via a messaging service;

FIG. 5 illustrates yet another example flowchart of a method for sending content of a third party website via a messaging service; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method, a computer-readable storage device and an apparatus for sending content of a third party website via a messaging service. Third party websites generally provide a rich amount of content. In addition, with the advent of social networking users may want to send or share content that the users find on the third party websites. Sharing content on the third party websites also helps the third party website providers as more traffic is brought to the third party's websites and helps increase the popularity of the websites.

Currently, a user may share content on the third party website by uploading the content to a social networking website such as Facebook® or Twitter®. Another option may be to insert the content into an email or attach the content to the email manually by the users. However, users cannot share content on the third party websites using an instant messaging, short message service (SMS), multi-media messaging service (MMS) or text message. Text messages via a messaging service provide a convenient and fast method for users to exchange information and messages.

One embodiment of the present disclosure provides a source code (broadly comprising a plurality of software instructions, a software plug-in, a plurality of executable codes by a processor, a software applet and the like) to modify existing third party websites so that a share button is available. The share button may provide a one-click method for sharing content on the third party website via a messaging service (e.g., broadly including texting messaging, SMS messaging, MMS messaging, instant messaging, and the like). In one embodiment, the message originates from the third party website, as opposed to generating the message via the operating system of an endpoint device, and appears to the recipient as if the message came from the mobile endpoint device of the sender.

For example, a user may send content selected from a third party website to a recipient via a text message via an endpoint device, e.g., via a desktop computer. The recipient will receive the content in the text message and the text message will appear as being originated from the sender's mobile endpoint device, e.g., a smart phone. The recipient may reply to the message and the reply may go to the mobile endpoint device and not to the desktop computer or the third party website that the message originated from.

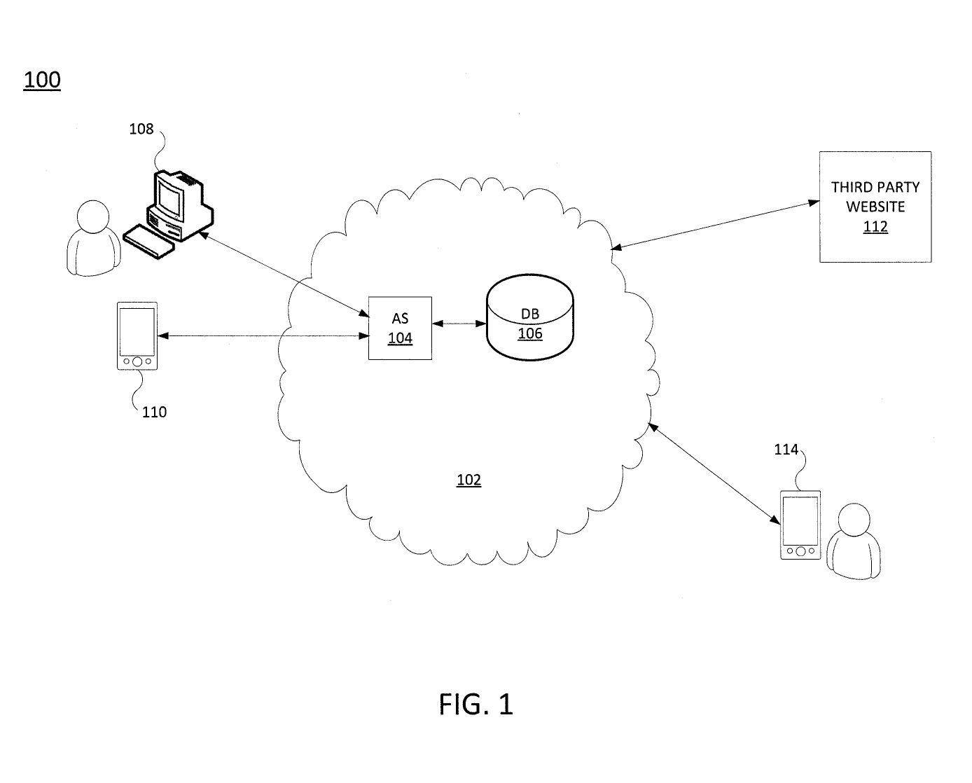

FIG. 1 is a block diagram depicting one example of a communications network 100. For example, the communication network 100 may be any type of communications network, such as for example, a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and the like related to the current disclosure. It should be noted that an IP network is broadly defined as a network that uses Internet Protocol to exchange data packets.

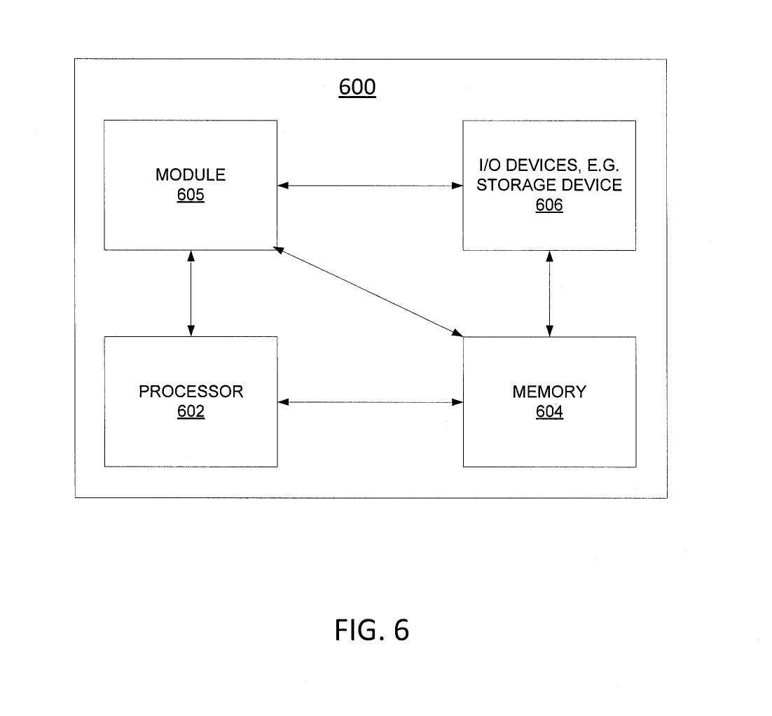

In one embodiment, the communications network 100 may include a core network 102. The core network 102 may include an application server (AS) 104 and a database (DB) 106. The AS 104 may be deployed as a hardware device embodied as a general purpose computer (e.g., the general purpose computer 600 illustrated in FIG. 6). In one embodiment, the AS 104 may perform the methods and functions described herein (e.g., the methods 300, 400 and 500 discussed below).

In one embodiment, the DB 106 may store the source code needed by a third party website 112 to enable the “one click” sharing of content via the messaging service provided by a service provider of the communications network 100. The DB 106 may also store all subscriber information and mobile endpoint telephone number(s) of each subscriber to send the messages via the messaging service provided by the communications network 100.

In one embodiment, the communications network may include one or more access networks (e.g., a cellular network, a wireless network, a wireless fidelity (Wi-Fi) network, a PSTN network, an IP network, and the like) that are not shown to simply FIG. 1. In one embodiment, the communications network 100 in FIG. is simplified and it should be noted the communications network 100 may also include additional network elements (not shown), such as for example, border elements, gateways, routers, switches, call control elements, various application servers, and the like.

In one embodiment, a user on an endpoint device 108 may be viewing a third party website 112 via the core network 102. In one embodiment, the user may also own a mobile endpoint device 110. The endpoint device 108 may be any type of endpoint device, e.g., a desktop computer, a laptop computer, a tablet computer, a netbook computer, and the like. The mobile endpoint device 110 may be any type of mobile endpoint device, e.g., a cellular telephone, a smart phone, a tablet computer, and the like, having a messaging capability, e.g., text messaging, SMS messaging, MMS messaging or instant messaging capability.

In one embodiment, the third party website 112 may be in communication with the core network 102 and the AS 104. The AS 104 may provide the third party with website source code that can be applied to the third party website 112. The source code is for modifying the third party website 112 such that a “share” button may be available on the third party website.

In one embodiment, the share button may allow a user browsing the third party website 112 using the endpoint device 108 to share a content on the third party website 112 to a mobile endpoint device 114 of a user that is associated with a telephone number provided by the sender via a message using a messaging service. Notably, the mobile endpoint device 114 does not necessarily have to be a cellular telephone. For example, if the recipient subscribes to cloud services for receiving messages, the mobile endpoint device 114 may be a tablet computer or laptop computer that the recipient may use to view and reply to messages sent to the telephone number. In other words, the mobile endpoint device 114 may be any type of mobile endpoint device 114 capable of receiving messages via a messaging service similar to the mobile endpoint device 110.

In one embodiment, the content may be sent as a text message and appear as if the message came from the mobile endpoint device 110 and not the third party website 112 or the endpoint device 108. In addition, the user of the mobile endpoint device 114 may reply to the message and the message is sent to the mobile endpoint device 110 as a text message via the messaging service.

It should be noted that although a single third party website 112 is illustrated in FIG. 1, any number of third party websites may be deployed. In addition, although only a single endpoint device 108 and two mobile endpoint devices 110 and 112 are deployed, any number of endpoint devices and mobile endpoint devices may be deployed.

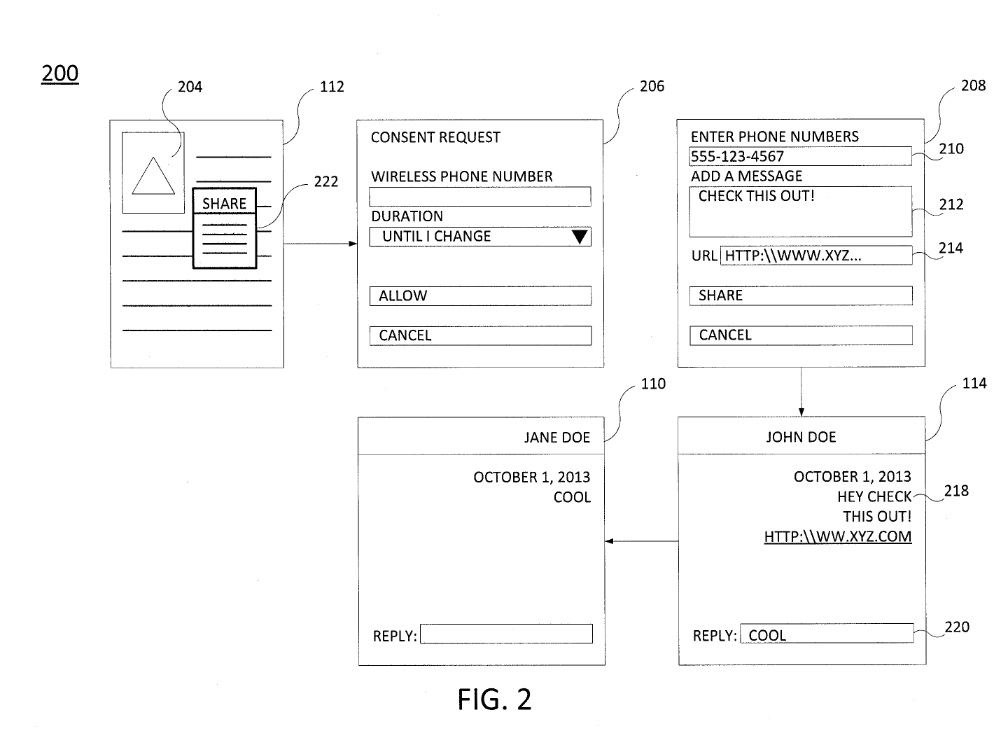

FIG. 2 illustrates illustrative screen shots of the various devices as the content is selected from the third party website 112 and shared with the mobile endpoint device 114 from the endpoint device 108. In one embodiment, the endpoint device 108 may display the third party website 112. The third party website 112 may be enabled with the source code to provide a share button for content on the website 112.

A user may select a content on the third party website 112. In one embodiment, the content may be an image or a sequence of images (e.g., a video, a picture, and the like) or a link or hyperlink to a website. In FIG. 2, the user may select a picture 204.

In one embodiment, a share button 222 may appear by right clicking over the picture 204. In another embodiment, the share button 222 may appear by hovering a mouse or cursor over the picture 204. The share button 222 may also include a list of recently used telephone numbers, frequently used telephone numbers, one or more telephone numbers of a user's contact list or address book, and the like. As a result, a user may select a telephone number and “one-click” share the picture 204 as a message via a messaging service.

In another embodiment, clicking on the share button 222 may open a consent request screen 206 if the user is selecting the share button 222 for the first time. The consent request screen 206 may collect consent and verify a mobile telephone number of the user to allow messaging and notify the user of a user agreement, that messaging charges may apply and the like. The mobile telephone number and consent are managed by the service provider of the communications network 100. In other words, although the consent request screen 206 is opened in the third party website 112, the information that is entered and accepted is collected and managed by the service provider of the communications network 100.

Once the user accepts the consent, a cookie may be stored on a browser of the endpoint device 108. In one embodiment, the consent request screen 206 may no longer appear as long as the cookie is present and has not expired. In one embodiment, the cookie may expire after a predefined period (e.g., a day, a week, a month, and the like).

In one embodiment, after the consent request screen 206 or if the user is not clicking the share button 222 for the first time, a message screen 208 may appear. The message screen 208 may include the picture 204 selected by the user that will be sent as a message. The user may enter a destination mobile telephone number 210 and optionally include a personal message 212. In one embodiment, as the user begins entering a telephone number, the field may auto fill the remaining numbers based upon previously entered telephone numbers or numbers found in the user's contact list or address book. In one embodiment, the picture 204 is included as a link or universal resource locator (URL) address 214.

The user may then hit the “send” button from the message screen 208 and the message is sent from the third party website 112 to the AS 104 of the communications network 100. The AS 104 may know the sender of the message as the DB 106 stores the user's mobile telephone number during the consent request screen 206. The AS 104 may then forward the content included in the message from the third party website 112 and send the message via the messaging service to the telephone number entered in the message screen 208, or selected from the share button 222. The recipient may then view the message via one or more mobile endpoint devices 114 associated with the telephone number.

In one embodiment, the message 218 appears on the mobile endpoint device 114 as if the message was sent as a messaging service message (e.g., a text message, SMS message, MMS message, instant messaging message, and the like). For example, the mobile endpoint device 114 displays the message as if the message originated from the mobile endpoint device 110 of the user, e.g., John Doe. As a result, the recipient can reply to the message and the reply 220 will be sent to the mobile endpoint device 110 of the user via the messaging service.

It should be noted that the message appears to have been sent by the mobile endpoint device 110 even though the message originated from the third party website 112 via the endpoint device 108. In addition, the recipient may immediately reply using the messaging service and the response may go to the mobile endpoint device 110 of the sender.

It should also be noted that the message originates from the third party website 112. In other words, the message does not originate from software running on an operating system of the endpoint device 108. Said another way, the source code that is applied to the third party website and not to the operating system, is providing the share button 222 that allows content on the third party website 112 to be shared via a message sent via the messaging service.

In one embodiment, the source code to enable the share button for sharing content via a messaging service may be provided to the third party website 112 by the communications network service provider on a subscription basis or paid basis. In another embodiment, the source code may be provided free of charge and the communications network service provider may generate revenue by advertisements appearing on the share button 222 for one-click embodiments or on the message screen 208 if the message screen 208 is used. In another embodiment, the communications network service provider may provide the source code for free and generate revenue from the additional text messages that are sent via the messaging service.

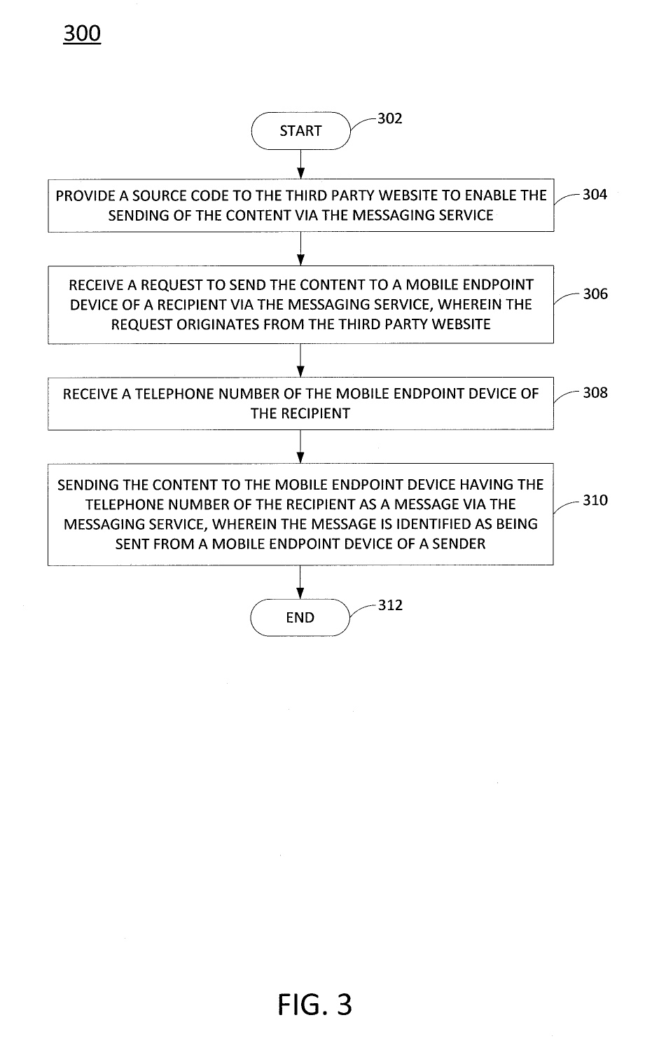

FIG. 3 illustrates a flowchart of a method 300 for sending a content of a third party website via a messaging service. In one embodiment, the method 300 may be performed by the AS 104 or a general purpose computer as illustrated in FIG. 6 and discussed below.

The method 300 starts at step 302. At step 304 the method 300 provides a source code to the third party website to enable the sending of the content via the messaging service. For example, the source code may be applied to the third party website to enable the website to display a share button.

At step 306, the method 300 receives a request to send the content to a mobile endpoint device of a recipient via the messaging service, wherein the request originates from the third party website.

In one embodiment, the source code to enable the share button for sharing content via a messaging service may be provided to the third party website service provider on a subscription basis or paid basis. In another embodiment, the source code may be provided to the third party website service provider for free and the communications network service provider may generate revenue by advertisements from the additional text messages that are sent via the messaging service.

At step 308, the method 300 receives a telephone number of the mobile endpoint device of the recipient. For example, a message may be received that originates from the third party website that includes the content selected by a user, an optional personal message and the telephone number associated with mobile endpoint device of the recipient.

At step 310, the method 300 sends the content to the mobile endpoint device associated with the telephone number of the recipient as a message via the messaging service, wherein the message is identified as being sent from a mobile endpoint device of a sender. For example, the communications may take the information received from the third party website and forward the content to the recipient via a message sent via the messaging service. In addition, the message is sent to the telephone number that may have one or more endpoint devices that are associated with the telephone number, thereby allowing the recipient to view and reply to the message from any endpoint device. For example, the recipient may subscribe to cloud services for the telephone number.

The message may be a text message, an SMS message, an MMS message, an instant messaging message, and the like. It should be noted that the messaging service does not include email services for this disclosure. The message may be sent to include the mobile telephone number of a sender's mobile endpoint device to make the message appear to the recipient as the message was sent from the sender's mobile endpoint device. Notably, even though the message originated from the third party website and selected via a different endpoint device, the message appears to be from the sender's mobile endpoint device. As a result, the recipient may reply to the message and the sender may receive the message on the sender's mobile endpoint device as a message sent by the messaging service. The method 300 ends at step 312.

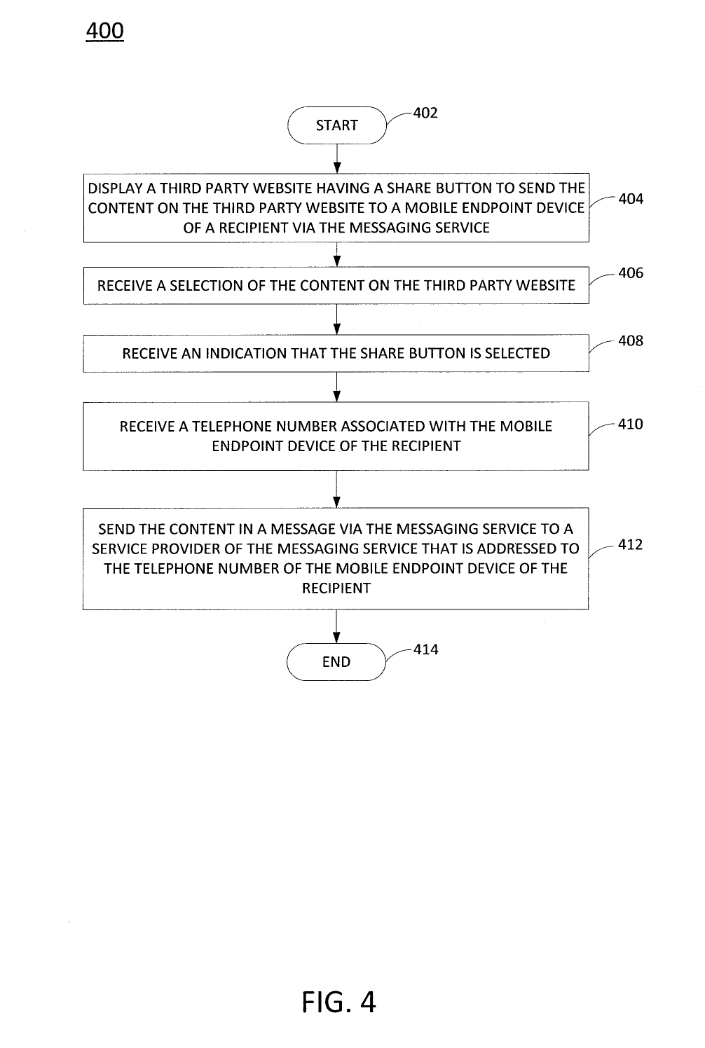

FIG. 4 illustrates a flowchart of a method 400 for sending a content of a third party website via a messaging service. In one embodiment, the method 400 may be performed by the endpoint device or a general purpose computer as illustrated in FIG. 6 and discussed below.

The method 400 starts at step 402. At step 404, the method 400 displays a third party website having a share button to send the content on the third party website to a mobile endpoint device of a recipient via the messaging service. The third party website may include a source code that allows the share button to appear and functions as described above.

At step 406, the method 400 receives a selection of the content on the third party website. For example, the user may select a link, hyperlink, a picture or a video on the third party website that the user wants to share with a recipient.

At step 408, the method 400 receives an indication that the share button is selected. For example, a user may select the share button with the user's finger or pointer if the endpoint device has a touch screen or by clicking on the share button using a pointer or cursor.

At step 410, the method 400 receives a telephone number associated with the mobile endpoint deice of the recipient. For example, if a one-click embodiment is enabled, the share button may display one or more recently used telephone numbers, one or more frequently used telephone numbers or one or more contacts imported from the user's contact list or address book. In another embodiment, if the message screen is used as a pop-up window, then the user may manually enter the telephone number in the message screen.

At step 412, the method 400 causes the third party website to send the content in a message via the messaging service to a service provider of the messaging service that is addressed to the telephone number associated with the mobile endpoint device of the recipient. For example, the message including the selected content, an optional personal message and the telephone number of the mobile endpoint device of the recipient may be sent to the service provider of the communications network or the messaging service. The service provider may then forward the message and content to the mobile endpoint device of the recipient as a message of the messaging service.

Notably, when the recipient replies to the message using the messaging service, the reply is sent to the mobile endpoint device of the user and not the endpoint device performing the method 400. In other words, the endpoint that is used to initiate and originate the message is not the endpoint that receives the reply from the recipient if the recipient sends a reply. The method 400 ends at step 414.

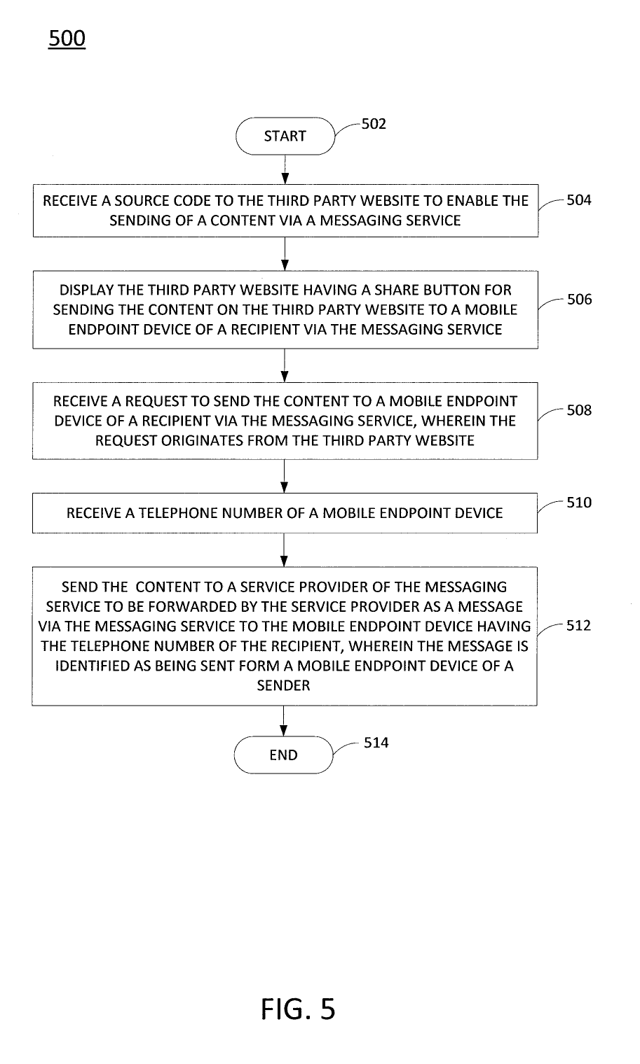

FIG. 5 illustrates a flowchart of a method 500 for sending a content of a third party website via a messaging service. In one embodiment, the method 500 may be performed by the third party website or a general purpose computer as illustrated in FIG. 6 and discussed below.

The method 500 starts at step 502. At step 504, the method 500 receives a source code to the third party website to enable the sending of a content via a messaging service. In one embodiment, the source code may be provided to the third party website service provider by the communications network service provider on a subscription basis or paid basis. In another embodiment, the source code may be provided to the third party website for free and the communications network service provider may generate revenue by advertisements from the additional text messages that are sent via the messaging service.

At step 506, the method 500 displays the third party website having a share button for sending the content on the third party website to a mobile endpoint device of a recipient via the messaging service. In other words, the share button is part of the website and not part of the operating system of the endpoint device displaying the third party website or the software of the web browser used by the endpoint device. In other words, the source code allows the third party website to share content using a message sent via a messaging system regardless of whether or not the endpoint used to display the third party website is capable of sending a text message, SMS message, MMS message, instant messaging message, and the like.

At step 508, the method 500 receives a request to send the content to a mobile endpoint device of a recipient via the messaging service, wherein the request originates from the third party website. For example, a user may select the share button on the third party website.

At step 510, the method 500 receives a telephone number. For example, the third party website may display one or more recently used telephone numbers, one or more frequently used telephone numbers or one or more telephone numbers imported from a user's contact list or address book for a one-click embodiment. Alternatively, a pop-up message screen may be displayed and the user may manually enter a telephone number.

In one embodiment, the recipient may subscribe to cloud services to enable the recipient to view and reply to messages sent to the telephone number on any endpoint device. Thus, the telephone number may be associated with one or more endpoint devices of the recipient.

At step 512, the method 500 sends the content to a service provider of the messaging service to be forwarded by the service provider as a message via the messaging service to the mobile endpoint device associated with the telephone number of the recipient, wherein the message is identified as being sent from a mobile endpoint device of a sender. For example, the message including the selected content, an optional personal message and the telephone number of the mobile endpoint device of the recipient is sent to the service provider of the communications network or the messaging service. The service provider may then forward the message and content to the mobile endpoint device of the recipient as a message of the messaging service.

Notably, when the recipient replies to the message using the messaging service, the reply is sent to the mobile endpoint device of the user and not the third party website. The method 500 ends at step 514.

It should be noted that although not explicitly specified, one or more steps or operations of the methods 300, 400 and 500 described above may include a storing, displaying and/or outputting step as required for a particular application. In other words, any data, records, fields, and/or intermediate results discussed in the methods can be stored, displayed, and/or outputted to another device as required for a particular application. Furthermore, steps, operations or blocks in FIGS. 3-5 that recite a determining operation, or involve a decision, do not necessarily require that both branches of the determining operation be practiced. In other words, one of the branches of the determining operation can be deemed as an optional step.

FIG. 6 depicts a high-level block diagram of a general-purpose computer suitable for use in performing the functions described herein. As depicted in FIG. 6, the system 600 comprises a hardware processor element 602 (e.g., a central processing unit (CPU), a microprocessor, or a multi-core processor), a memory 604, e.g., random access memory (RAM) and/or read only memory (ROM), a module 605 for sending a content of a third party website via a messaging service, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed manner for a particular illustrative example, i.e., the steps of the above method(s) or the entire method(s) are implemented across multiple general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for sending a content of a third party website via a messaging service (e.g., a software program comprising computer-executable instructions) can be loaded into memory 604 and executed by hardware processor element 602 to implement the steps, functions or operations as discussed above in connection with the exemplary methods 300, 400 and 500. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for sending a content of a third party website via a messaging service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for sending a content of a third party website via a messaging service, comprising:
providing, by a processor, a source code to the third party website to enable the sending of the content via the messaging service;
receiving, by the processor, a request to send the content to a mobile endpoint device of a recipient via the messaging service, wherein the request originates from the third party website;
receiving, by the processor, a telephone number of the mobile endpoint device of the recipient; and
sending, by the processor, the content to the mobile endpoint device associated with the telephone number of the recipient as a message via the messaging service, wherein the message is identified as being sent from a mobile endpoint device of a sender.

2. The method of claim 1, further comprising:
receiving, by the processor, a reply message from the mobile endpoint device of the recipient via the messaging service; and
sending, by the processor, the reply message to the mobile endpoint device of the sender.

3. The method of claim 2, wherein the mobile endpoint device of the sender is different from an endpoint device used by the sender to view the third party website and to trigger the request for sending the content to the mobile endpoint device of the recipient.

4. The method of claim 1, wherein the content comprises a link to a website.

5. The method of claim 1, wherein the content comprises an image.

6. The method of claim 1, wherein the messaging service comprises a short message service message.

7. The method of claim 1, wherein the messaging service comprises a multimedia message service.

8. The method of claim 1, further comprising:
sending, by the processor, a consent request to identify the sender via a pop-up message on the third party website when the request to send the content that is received is a first request from the sender.

9. A method for sending a content of a third party website via a messaging service, comprising:
displaying, by a processor, the third party website having a share button to send the content on the third party website to a mobile endpoint device of a recipient via the messaging service;
receiving, by the processor, a selection of the content on the third party website;
receiving, by the processor, an indication that the share button is selected;
receiving, by the processor, a telephone number associated with the mobile endpoint device of the recipient; and
sending, by the processor, the content in a message to a service provider of the messaging service that is addressed to the telephone number associated with the mobile endpoint device of the recipient.

10. The method of claim 9, wherein the content comprises a link to a website.

11. The method of claim 9, wherein the content comprises an image.

12. The method of claim 9, wherein the messaging service comprises a short message service message.

13. The method of claim 9, wherein the messaging service comprises a multimedia message service.

14. The method of claim 9, further comprising:
displaying, by the processor, a consent request to identify the sender via a pop-up message on the third party website when the indication that the share button is received for a first time from the sender.

15. The method of claim 14, wherein a cookie containing consent information from the sender is stored on a browser of the endpoint device displaying the third party website.

16. A method for sending a content of a third party website via a messaging service, comprising:
receiving, by a processor, a source code for the third party website to enable the sending of the content via the messaging service;
displaying, by the processor, the third party website having a share button for sending the content on the third party website to a mobile endpoint device of a recipient via the messaging service;
receiving, by the processor, a request to send the content to a mobile endpoint device of the recipient via the messaging service;
receiving, by the processor, a telephone number; and
sending, by the processor, the content to a service provider of the messaging service to be forwarded by the service provider as a message via the messaging service to the mobile endpoint device associated with the telephone number of the recipient, wherein the message is identified as being sent from a mobile endpoint device of a sender.

17. The method of claim 16, wherein the content comprises a link to a website.

18. The method of claim 16, wherein the content comprises an image.

19. The method of claim 16, wherein the messaging service comprises a short message service message.

20. The method of claim 16, wherein the messaging service comprises a multimedia message service.
